(19) United States
(12) Patent Application Publication
(10) Pub. No.: US 2012/0168279 A1
(43) Pub. Date: Jul. 5, 2012

(54) DEVICE FOR TRANSPORTING CONTAINERS

(75) Inventor: Andreas Baechle, Rickenbach (DE)

(73) Assignee: ROBERT BOSCH GMBH, Stuttgart (DE)

(21) Appl. No.: 13/380,985

(22) PCT Filed: Apr. 29, 2010
(86) PCT No.: PCT/EP2010/055776

§ 371 Date: Mar. 23, 2012

(30) Foreign Application Priority Data
Jun. 29, 2009 (DE) 10 2009 027 280.1

(51) Int. Cl. B65G 15/14; B65G 21/20; B65G 15/44; B65G 47/24

(52) U.S. Cl. 198/382; 198/620

(57) ABSTRACT

In a device (10) for transporting containers (20), a first and a second lateral transport guide (14, 16) for guiding the containers (20) on both sides are associated with a belt-shaped container support (12) that can be moved in a transport direction (x). At least one of the transport guides (14, 16) can be moved in the transport direction (x) at the same speed as the container support (12), and the transport guides (14, 16) have clamping elements (8) for fixing the containers (20) between the first and the second transport guides (14, 16).

### BACKGROUND OF THE INVENTION

The present invention relates to a device for transporting containers having a container support that can be moved in a transport direction.

Containers or trays are typically transported through packaging plants with the aid of conveyors, belts or chains. In so doing, conveyor belts can flexibly transport different forms of containers by means of frictional engagement, whereas chains ensure an exact control and positioning of the containers by means of a positive-locking arrangement.

A particular point to consider is that the containers when empty are for the most part very light and consist of a thin easily malleable material, so that only small forces can be exerted on said containers. The container material is also for the most part very smooth so that only a small frictional force can be utilized.

The problem with belts is that the mostly very light trays can be easily shifted. This often occurs when loading the trays with a product; thus requiring the current position of each tray to be reacquired after each loading process, for example, by means of a vision system. Trays can also, however, totally unexpectedly shift their position at any time as a result of, for example, a draft, vibrations etc. In addition, any inclined container transport as is, e.g., necessary for creating packages having narrow products standing side by side (on edge packaging style) cannot be implemented using a belt. Due to the small amount of friction between tray and belt, the trays in this case would slide from the belt under the force of gravity.

The aforementioned problems can be avoided with the aid of a chain, which transports the containers by means of a positive-locking arrangement. The chain, however, has a rigid pitch so that changing to another container size is only possible after complicated reconfiguration or restructuring thereof. For the most part, irregularly formed trays can in no way be directly inserted onto a chain but require an adapter, a specially adapted carrier piece, which likewise must be adapted to each container size. The complex mechanical construction having many corners and joints tends to collect dirt and does not lend itself to applications, which require a complete and frequent cleaning in order to avoid a contamination of the products, e.g. with germs. In order to increase flexibility, chains can be equipped with entrainment members capable of being lowered; however, costs, complexity as well as the aforementioned disadvantages accordingly increase.

There are approaches, which bypass the problems of belts by increasing friction, e.g., by using a vacuum belt. This is, however, not cost effective in the case of pick-and-place packaging plants, which include conveying sections comprising many meters of length, due to the large vacuum demand.

In addition, not all containers have a continuous supporting surface, which leads to considerable losses in vacuum.

The use of vacuum belts for holding containers is associated with large costs for maintaining a sufficient vacuum, a high noise level and considerable energy costs. To ensure compliance with hygiene guidelines, the use of vacuum belts furthermore requires an increase in cleaning work, which has corresponding additional costs.

Alternative transport systems, as, e.g., walking beam transport systems, in which the containers are transported in a stepwise manner by means of beams that raise and lower, are likewise mechanically very complex. Systems of this kind are also often equipped with vacuum in order to safely carry the containers.

A further conveyor principle is, e.g., demonstrated by the BOSCH Rexroth Varioflow System. In this case, the containers are so tightly clamped that they are held against gravitational force. The clamping elements are moved and the clamped container is thus transported. Only very stable containers can be moved in this way because large clamping forces are required. The entire transport work is performed by the clamping elements being moved. This conveyor principle cannot be used for the transport of thin, easily malleable trays, which are typically used in packaging plants.

### SUMMARY OF THE INVENTION

The aim underlying the invention is to provide a transport system for containers, particularly for trays and boxes, for a packaging plant, which combines the flexibility of a belt system with the high degree of reliability of a chain conveyance. A shifting of the containers is particularly to be prevented so that an initially ascertained position of a container in relation to the transport system is maintained during the entire pass through the packaging plant. In addition, the transport system is to be capable of use in applications, which require the containers to be inclined at an angle with respect to the direction of transport. The system is to be easy to clean and cost-effectively produced.

In order to meet the aim according to the invention, a first and a second lateral transport guide for guiding the containers on both sides are associated with the belt-shaped container support in a device of the kind mentioned at the beginning of the application. At least one of the transport guides can be moved in the transport direction at the same speed as the container support, and the transport guides have clamping elements for fixing the containers between the first and the second transport guides.

The required high degree of flexibility requires a conveyance device, which transports the containers substantially by means of frictional engagement. Because said containers in the loaded state are very heavy in comparison to the inherent rigidity thereof, it may be necessary to support the same across the total container surface. For that reason, a conveyor belt is preferably used, on which the container rests with the entire bottom surface thereof. Such a conveyor belt offers a degree of flexibility and good support and furthermore has good cleaning features.

The fixing of the containers results from an additional lateral clamping. Because said clamping only prevents the containers from shifting and does not support the same, it can be very much weaker than, for example, is the case in the Rexroth Varioflow system. The result of said clamping is that the relative position of said containers to the conveyor belt does not change again during conveyance.

Two opposing clamping elements which move with the container are required to achieve the necessary clamping. Said elements have to both move exactly at the same speed—typically at the speed of the conveyor belt—so that the containers do not start to rotate even on long conveyance sections. In the event that a rotation said containers is desired, this can be achieved by a targeted change in the speeds of the clamping elements.

The container support is preferably a conveyor revolving in a conveying plane, for example a plate, chain or vibration conveyor, and the clamping elements are preferably designed to introduce a clamping force in a clamping plane which, e.g., is substantially parallel to the conveying plane.

The clamping elements associated with the lateral transport guides are preferably located opposite one another, and said clamping elements are designed as lateral guide elements.

One of the lateral transport guides can be connected to the belt-shaped container support. The clamping elements of the lateral transport guide can be fixedly connected in the shape of cams to said belt-shaped container support.

At least one of the lateral transport guides can preferably be driven individually.

At least one of the lateral transport guides is preferably equipped with flexible, resilient clamping elements.

The flexible clamping elements are preferably adjusted to the container such that they reliably fix said container, however with as little force as possible, by means of clamping. In addition, said container may not be lifted off of the container support. This means that the introduction of the clamping force has to occur preferably horizontally or that is to say in a clamping plane parallel to the container support. In order to achieve this end, clamping elements are required where needed, which are adapted to each type of container, very resilient and can be easily switched when necessary.

At least one of the transport guides can be arranged inclined against the conveying plane so as to press the containers against the container support, i.e. slightly downward sloping in the transport direction. In so doing, a slippage of the clamping elements would continuously occur in a downward direction, whereby the containers are pressed against said container support.

The second clamping element required for fixing the containers can typically be used for all types of containers because it does not have to be resiliently constructed.

The lateral transport guide equipped with resilient clamping elements can be laterally displaceable transversely to the transport direction. By changing the distance of the guide elements to one another—e.g. by the resilient transport guide or that is to say the resilient clamping element being arranged in a displaceable manner—the system can be simply adapted to different container widths.

The lateral transport guide equipped with resilient clamping elements can be embodied as a looped belt.

The resilient clamping elements can be embodied as lips.

The resilient clamping elements can also be embodied as coated toothed belts, for example toothed belts having Super Grip® coating. Processed coatings such as, e.g., Linaplus® are also conceivable. Vertical spikes can also, e.g., be introduced into the coating as resilient elements.

The resilient clamping elements can also be embodied as individual “plastic springs” on a transport element.

In order to align the containers, at least one of the transport guides can run at an acute angle with respect to the other transport guide on an entry section. At the end of the entry section, at least one stop bar which can be pivoted in the conveying plane is provided as a stop for the containers

In order to save on cost and space, the clamping elements can be resiliently configured on only one side of a container. A rigid stop is introduced on the other side. This stop offers the advantage of a straight stop surface, which allows for an exact positioning of the containers. Said stop can most simply be moved at the same speed as the conveyor system by attaching it directly to the same. In order to facilitate the deflection around the conveyor drums, the stop can be vertically incised or said stop comprises totally independent segments, which are so narrow that they can be guided around the deflection radius of the conveyor belt. Cams, which are welded onto the belt, are, for example, are well suited in this case for their normal use as entrainment members.

The conveyor belt and the resilient lateral guides are driven at exactly the same speed in order to prevent the containers from shifting. In this case, the speed of the conveyor belt can, for example, be acquired as the master speed by means of an encoder. This speed signal then controls the actuation of the lateral guide, which must occur without slippage.

The resilient element must be selected such that it exerts a reliable clamping force on the container without, for example, lifting said container due to an unfavorable direction of force or deforming said container due to too great of a clamping force. Because the containers are made from thin, relatively instable plastic or cardboard, a high degree of resiliency is required in order to ensure the necessary clamping force without inadmissibly high fluctuations. Said resiliency must especially be present in instances when tolerances exist in container width or when said containers assume slightly different orientations during clamping. In addition, the resilient element must be embodied such that it can be deflected via conveyor drums. First of all, this requires the elements to be adapted to the respective containers.

Evidence has shown that a profile comprising loop cleats is particularly capable of clamping a plurality of different containers. In order to prevent products from shifting on the belt, these very resilient belts are typically used as gentle conveyor belts for fruit.

To ensure a reliable conveyance of the containers, the profile comprising loop cleats must be configured such that at least three loops clamp the container.

As an alternative, a resilient clamping element can be used while exploiting the flexural weakness of said element when it is inclined at an angle. The ideal angle between clamping element and a perpendicular to the conveyor belt lies preferably between 15-20°. Besides optimal accessibility from above, an ideal force direction is also ensured at this angle.

This clamping element can, for example, be cost effectively produced as a belt such that a belt webbing is fastened as a resilient lip to a V-notch applied as the basic element to a toothed belt.

Alternatively the option exists here to directly apply the lip to the toothed belt and thereby to maintain an inclined position, which might be required in this case, by means of a rotation of the drive belt during transport.

In addition, coatings as resilient elements are conceivable. This has cost advantages because many coatings are standardly available (e.g. Supergrip®). A processing of a soft coating material, e.g., as unstable prisms is also conceivable. This form provides a type of self-cleaning effect in the deflections as well as small deflection radii.

When selecting the resilient element, the following applies:

A looped belt is preferred for unstable containers with large contact surfaces, which are transverse to the direction of motion. Loops have the advantage of smaller contact pressing forces.

In the case of narrow containers, which are transversely conveyed, a resilient profile inclined at about 15° or coated toothed belts are more suitable because loops can cant; thus allowing the container to rotate.

The conveyor belt should primarily carry the containers with very small frictional engagement. In this way, the positioning and clamping of the containers between the lateral guide elements is disturbed as minimally as possible.

It should be further noted that the lateral guides can also be partially used. The containers are for the most part sufficiently fixed by the product weight as soon several products have been inserted.

When circulating on the conveyor belt, the guide elements can be cleaned by means of scrapers, brushes or if required a “wash station”. The operation is thereby not compromised by a gradual collection of dust and dirt.

The advantages which result with the device according to the invention include among other things:

reliable transport of the containers without shifting

hence camera systems are not required to detect the container position prior to each packaging stage

no relative movement—no cosmetic damage

good sanitation, easy to clean

simple adaptation to different container sizes and shapes

even irregularly shaped containers can be conveyed without additional carrier elements

up to now a very complicated conveyance system was required for cardboard boxes with attached covers and for tall containers

may be also be used for transporting containers which are inclined at an angle

simple, cost-effective design

### BRIEF DESCRIPTION OF THE DRAWINGS

Additional advantages, features and details of the invention become evident in the following description of preferred exemplary embodiments as well as with the aid of the drawings, which serve merely to explain said invention and are not meant to limit the interpretation thereof. The drawings schematically show in

FIG. 1 an oblique view of a conveying device for containers;

FIG. 2 the top view of a conveying device with laterally clamped containers;

FIG. 3 an oblique view of a conveying device with laterally clamped containers;

FIGS. 4-6 a cross-sectional view of clamping elements adapted to different container

(a) shapes;

FIG. 7 mode of operation of a clamping element;

FIG. 8 a further arrangement of a clamping element in cross section

FIG. 9 a cross-sectional view through a toothed belt having a lip attached thereto;

FIG. 10 the arrangement of the toothed belt in FIG. 9 inclined at an angle;

FIG. 11 an oblique view of an endless conveyor belt having loop-shaped clamping elements;

FIG. 12 the top view of an entry section of a conveying device.

### DETAILED DESCRIPTION

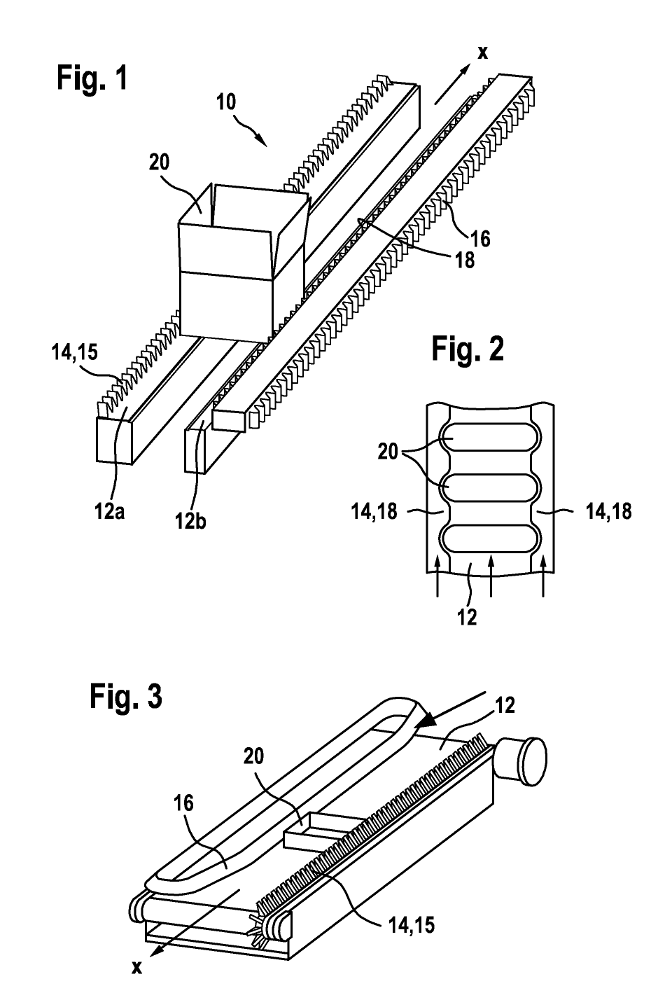

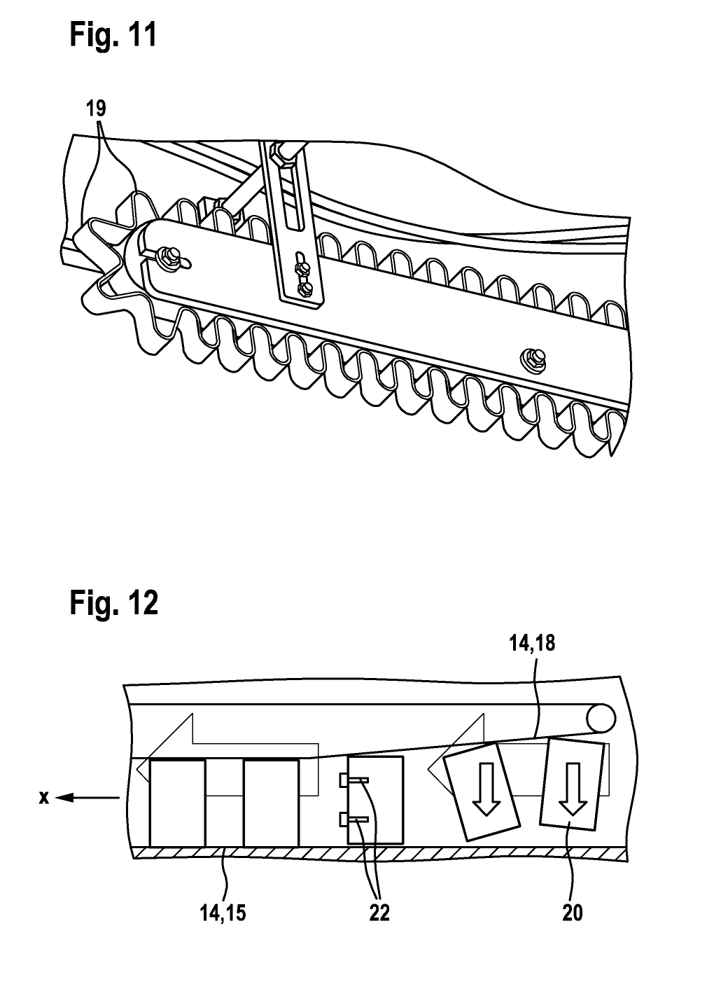

A conveying device 10 shown in FIG. 1 comprises a belt-shaped container support 12 that can be moved in a transport direction x and lateral transport guides 14, 16 disposed on each side of the container support 12. In the example shown, said container support 12 comprises two conveyor belts 12a, 12b disposed parallel to one another and running synchronously at the same speed. A first lateral transport guide 14 consists in this case of a plurality of cams 15 fixedly connected to one of the conveyor belts 12a and used as stop elements for containers 20 which are supported on the container support 12 or that is to say the conveyor belts 12a, 12b and in the example shown are configured as boxes. The second lateral transport guide 16 is configured as a revolving belt having clamping elements configured in the shape of resilient loops (FIG. 11). The profile comprising loop cleats is designed for reliable conveyance in such a way that at least three loops 19 clamp the container 20.

In the arrangement shown in FIG. 1, the loops 19 are only resiliently deformed when the containers 20 are clamped between the fixed cams 15 on the first lateral transport guide 14 and said resilient loops19. The first lateral transport guide 14 comprising the cams 15 serves as a straight stop surface and thereby facilitates an exact positioning of the containers 20.

In the arrangement shown in FIG. 2, both lateral transport guides 14, 16 are resiliently equipped or rather equipped with resilient clamping elements 18. The containers 20 are in this case held on both sides between resiliently deformed clamping elements 18.

FIG. 3 shows an arrangement having a single conveyor belt serving as the container support 12. The container 20 is in this case a basin-like tray as is used, for example, in the packaging of biscuits. As in the arrangement shown in FIG. 1, a first lateral transport guide also comprises in this instance a plurality of cams 15 fixedly connected to the conveyor belt and serving as stop elements for the containers 20. The second lateral transport guide 16 is a revolving belt having clamping elements which are not defined in detail.

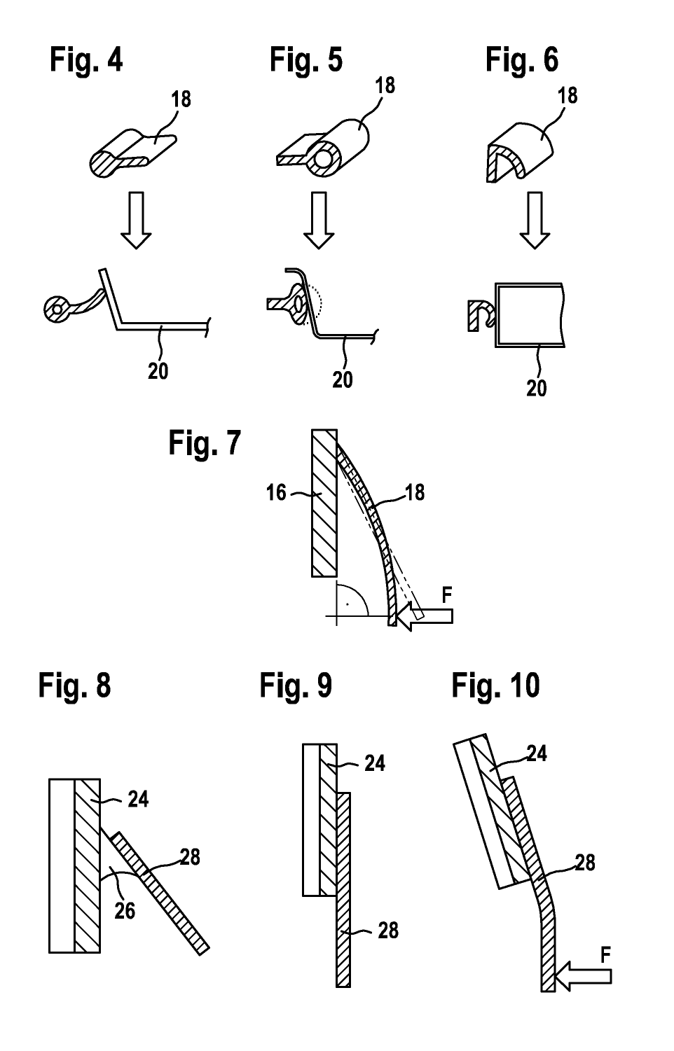

In FIGS. 4-6, different embodiments of clamping elements 18a, 18b, 18c are depicted. These are essentially configured in such a way that besides exerting a clamping force directed parallel to the container support 12, they press the containers 20 against said container support 12; thus ensuring the required frictional engagement between container 20 and container support 12 for a reliable conveyance of the light, empty containers.

A clamping element suitable for thin-walled, light containers 20 is depicted in FIGS. 7 and 8. The clamping element 18 consists of a toothed belt 24 as the basic element having a v-shaped profile, on which a belt webbing 28 is fastened as a resilient lip.

An alternative embodiment is depicted in FIG. 9. The lip is applied in this case directly to the toothed belt. An inclined position of the lip 28, which might be required here, can, for example, be achieved by a rotation of the toothed belt 24 during conveyance (FIG. 10).

Particularly rectangular containers are initially transferred to the conveyor belt by a destacker, which is not shown. In so doing, the destackers allow the containers to fall onto the conveyor belt in an uncontrolled manner. When entering the conveyance section and particularly between the lateral clamping devices, the containers have to be aligned, otherwise said containers would be clamped in a slanted or skewed fashion.

As shown in FIG. 12, one of the lateral transport guides 14, 16—in this instance the second transport guide 16 comprising the resilient clamping elements 18—is initially disposed obliquely along an entry section for the purpose of aligning the containers 20. This disposal enables said containers 20 to be pushed in the direction of the first lateral transport guide 14 comprising the fixed stop elements. In addition, this action can be assisted by a system of pivoting stop bars 22, which also simultaneously establish a defined distance between said containers 20.

Irregular containers, which do not have a defined preferred orientation, can also be accepted by using large tolerances in the positioning thereof and are then further transported in this manner. A camera system at the beginning of the conveyance route detects the orientation, with which the container is transported. Said orientation does not change during the conveyance as a result of clamping.

### REFERENCE NUMERAL LIST

10 conveying device
12,12a,b container support, conveyor belts
14 first lateral transport guide
15 cams on 14
16 second lateral transport guide
18 clamping elements
19 profile comprising loop cleats
20 container
22 stop bar
23 toothed belt
24 V-shaped profile
28 belt webbing, lip
x transport direction

1. A device for transporting containers (20), the device comprising a container support (12) that can be moved in a transport direction (x), characterized in that a first and a second lateral transport guide (14, 16) for guiding the containers (20) on both sides are associated with the container support (12) and at least one of the transport guides (14, 16) can be moved in the transport direction (x) at the same speed as said container support (12) and said transport guides (14, 16) have clamping elements (18) for fixing said containers (20) between said first and said second transport guide (14, 16).

2. The device according to claim 1, characterized in that the container support (12) is a conveyor revolving in a conveying plane.

3. The device according to claim 2, characterized in that the clamping elements (18) are configured to introduce a clamping force in a clamping plane substantially parallel to the conveying plane.

4. The device according to claim 2, characterized in that at least one of the transport guides (14, 16) is arranged inclined relative to the conveying plane in order to press the containers (20) against the container support (12).

5. The device according to claim 1, characterized in that the clamping elements (18) associated with the lateral transport guides (14, 16) are disposed opposite to one another.

6. The device according to claim 1, characterized in that the clamping elements (18) are configured as lateral guide elements.

7. The device according to claim 1, wherein the container support is belt-shaped, and wherein one of the lateral transport guides (14, 16) is connected to the belt-shaped container support (12).

8. The device according to claim 7, characterized in that the clamping elements (18) of one of the lateral transport guides (14, 16) are fixedly connected in the shape of cams (15) to the belt-shaped container support (12).

9. The device according to claim 1, characterized in that at least one of the lateral transport guides (14, 16) can be individually driven.

10. The device according to claim 1, characterized in that at least one of the lateral transport guides (14, 16) is equipped with flexible, resilient clamping elements (18).

11. The device according to claim 10, characterized in that the lateral transport guide (16) equipped with resilient clamping elements (18) can be laterally displaced transversely to the transport direction (x).

12. The device according to claim 10, characterized in that the lateral transport guide (16) equipped with resilient clamping elements (18) is a looped belt.

13. The device according to claim 10, characterized in that the resilient clamping elements (18) are configured as lips.

14. The device according to claim 1, characterized in that at least one of the transport guides (14, 16) runs at an acute angle relative to the other transport guide for the purpose of aligning the containers (20) on an entry section.

15. The device according to claim 14, characterized in that at least one stop bar (22) pivotable in the conveying plane is provided at the end of the entry section as a stop for the containers (20).
